(19) United States
(12) Patent Application Publication
(10) Pub. No.: US 2007/0247430 A1
(43) Pub. Date: Oct. 25, 2007

(54) Keyboard and mouse operation data recording/reproducing system and method thereof

(75) Inventor: Wei-min Huang, Shijr City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Aten International Co., Ltd.

(21) Appl. No.: 11/409,299

(22) Filed: Apr. 21, 2006

(51) Int. Cl. G09G 5/00

(52) U.S. Cl. 345/168

(57) ABSTRACT

A keyboard and mouse operation data recording/reproducing system for recording/reproducing or further editing, programming the operation data of a set of keyboard and mouse and method thereof. The keyboard and mouse operation data recording/reproducing system, coupled to a keyboard, a mouse, a display and at least one computer. The keyboard and mouse operation recording/reproducing system includes a keyboard and mouse recording unit, a memory, a mark generator and a keyboard and mouse emulator. The keyboard and mouse recording unit records keyboard and mouse operation data and reproduces the recorded keyboard and mouse operation data. The memory is for storing the recorded operation data. The mark generator generates marks for events of the recorded operation data while the recorded operation data is stored. The keyboard and mouse emulator receives the reproduced operation data to replay the keyboard and mouse operation to the computer.

### FIELD OF THE INVENTION

The present invention generally relates to a keyboard and mouse operation data recording/reproducing system for recording/reproducing and further editing the operation data of a set of keyboard and mouse, and more particularly to a keyboard and mouse operation data recording/reproducing system for replaying the recorded keyboard and mouse operation to the computer and method thereof.

### BACKGROUND OF THE INVENTION

Since the first time that a graphic user interface is implemented as standard in Macintosh OS for a personal computer, a set of keyboard and mouse as a human interface device has been popularly utilized in the graphic user interface for controlling a computerized system. Plenty of related software applications for such computerized system have been developed quickly and variously. The operations in these software applications also become more and more necessarily complicated. Consequently, many particular software programs, e.g. Ardamax Keylogger, AutoRecorder, or MacroMachine have a facility to record a series of keystrokes made by the user and to play back later are derived. The keystrokes are stored in a macro file. The macro file can be applied for the user to re-execute a complicated operation without repeating the series of keystrokes. Some particular recording programs also have a facility to record the movement of the mouse and to play back later as well as to play back the keystrokes of the keyboard. These particular software programs for recording the keystrokes or the movement of the mouse are all software dependent and installed in the Macintosh OS, Microsoft Windows or other kind operating systems. When one user is using these programs, which are totally software dependent or software and hardware dependent, i.e. involving prepositive settings of related hardware for the software application, installation, training and default setting for related software and hardware are necessary before the user is going to implement the particular recording programs. Meanwhile, these recording programs cannot be started until the operating system, where they are installed and has become complete ready. Before a computerized production is delivered to the market, a test engineer is going to have many routine tests on the computerized production which usually has an operating system, such as hardware test, function test, reliability test . . . etc usually has to be held when the operating system is not loaded and some other test may has to be held after the operating system has been loaded up to the computerized production. The routine tests are always routine, repeated, monotonous and regular operations to the computerized productions, for example, the keyboard and mouse operations. Therefore, a recording and reproducing system for keystrokes and the input of a cursor controller (mouse) is a great concept to reduce the routine, repeated, monotonous and regular test job. However, the prior art only provides record and replay facility only after the operation system has been installed and become complete ready. Moreover, being capable of recording/reproducing or even editing on the input of keyboard and mouse before the operation system is alive is more powerful to a test job which the prior art can not provide, either. Therefore, such software programs can't no longer satisfy a modern user's need for editing or programming the recorded content and link to the digital O/S for test or further multi-function, which can be developed.

Consequentially, there's a need to develop a keyboard and mouse operation data recording/reproducing system for recording/reproducing and further editing the operation data of a set of keyboard and mouse and method thereof for meeting the development of a digital system and many routine test on the computerized productions. What the test engineer needs to do is executing the test operation (e.g. series of input commands) or other necessary operation once with recording then reproduces the recorded operation to the same, follow-up computerized productions.

### SUMMARY OF THE INVENTION

To solve the foregoing drawbacks in the prior art, it is an object of the present invention is to provide a keyboard and mouse operation data recording/reproducing system for recording/reproducing and further editing, programming the operation data of a set of keyboard and mouse and method thereof.

To accomplish the above object, the present invention provides a keyboard and mouse operation data recording/reproducing system for recording/reproducing and further editing, programming the operation data of a set of keyboard and mouse and method thereof. The keyboard and mouse operation data recording/reproducing system, coupled to a keyboard, a mouse and at least one computer to receive a keyboard and mouse signal from the keyboard and the mouse, the keyboard and mouse operation recording/reproducing system includes a keyboard and mouse recording unit, a memory, a mark generator and a keyboard and mouse emulator. The keyboard and mouse recording unit watches for the keyboard and mouse to record operation data transformed from the keyboard and mouse signal and reproduce the recorded operation data. The memory coupled to the keyboard and mouse recording unit is for storing the recorded operation data. The mark generator generates a plurality of marks for events of the recorded operation data while the recorded operation data is stored in the memory. The keyboard and mouse recording unit marks the events of the recorded operation data as intervals inbetween while the recorded operation data is stored. The keyboard and mouse emulator emulates the keyboard and mouse according to the reproduced operation data received from the keyboard and mouse recording unit to replay the keyboard and mouse operation to the computer.

The method for recording/reproducing a keyboard and mouse operation data of a set of keyboard and mouse of a console for a connected computer, the method includes the steps:

recording keyboard and mouse operation data transformed from a keyboard and mouse operation signal;

marking events of the recorded operation data with marks while the operation data is stored; and

reproducing the recorded operation data for the computer according to the marks.

Furthermore, before the recording step, the method of present invention further includes a step of initializing the set of keyboard and mouse including zeroing the mark generator.

And after the step of reproducing the keyboard and mouse operation data, the method of present invention further includes a step of emulating the keyboard and mouse to replay the keyboard and mouse operation to the computer.

The keyboard and mouse operation data recording/reproducing system and method thereof according to the present invention is capable of recording/reproducing and further editing, programming the operation data of a set of keyboard and mouse. The user may edit the operation data by accessing the memory to view the content of the operation data. The user may cut, combine or do some montage on the operation data of his own free will to provide more combination possibility of replaying the keyboard and mouse operation to the computer but not only recording and reproducing the operation data.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A illustrates a functional block diagram of a keyboard and mouse operation data recording/reproducing system according to first embodiment of the present invention;

FIG. 1B illustrates a functional block diagram of a keyboard and mouse operation data recording/reproducing system further including a switch for selecting the source of keyboard and mouse operation data according to second embodiment of the present invention;

FIG. 2A illustrates a functional block diagram of a keyboard and mouse operation data recording/reproducing 1-port KVM adapter according to third embodiment of the present invention;

FIG. 2B illustrates a functional block diagram of a 4-port keyboard-video-mouse (KVM) switch capable of recording/reproducing keyboard and mouse operation data of keyboard and mouse according to fourth embodiment of the present invention; and

FIG. 3 shows a flowchart of the method for recording/reproducing a keyboard and mouse operation data of keyboard and mouse.

FIG. 4 shows an illustration for marking events of the recorded operation data as intervals with an axis of the reference frequency indexes or the counting indexes.

### DETAILED DESCRIPTION OF THE PREFERRED EMBODIMENTS

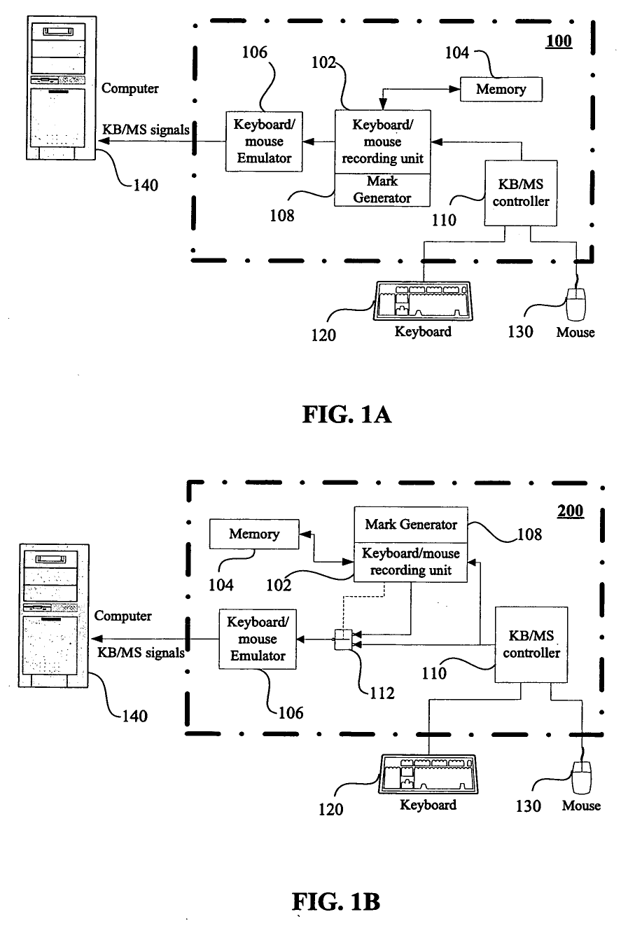

Please refer to FIG. 1A illustrating a block diagram of a keyboard and mouse operation data recording/reproducing system 100 for recording/reproducing the operation data of a set of keyboard and mouse according to first embodiment of the present invention. The keyboard and mouse operation data recording/reproducing system 100 includes a keyboard and mouse recording unit 102, a memory 104, a keyboard and mouse emulator 106, a mark generator 108 and a keyboard and mouse controller 110. The recording/reproducing system is coupled to a keyboard 120 and a mouse 130 through the keyboard and mouse controller 110 and coupled to a computer 140 (Computer) via the keyboard and mouse emulator 106.

The keyboard and mouse controller 110 transforms the keyboard and mouse operation signal from the keyboard 120 and the mouse 130 into the keyboard and mouse operation data. When a user start the record function of the recording/reproducing system, the keyboard and mouse recording unit 102 starts to record the keyboard and mouse operation data transformed from the keyboard and mouse signals. The memory 104 coupled to the keyboard and mouse recording unit 102 is for storing the recorded the operation data and waits for the user's command for reproducing later. The mark generator 108 generates marks for each event of the recorded operation data while the recorded operation data is stored to the memory. The events here mean any actions, keystrokes, movements or any input of the keyboard 120 and the mouse 130. The mark generator 108 can be a reference frequency generator or a counter generating reference frequency indexes or counter indexes as the marks for marking the events of the recorded operation data. The keyboard and mouse recording unit 102 reproduces the recorded keyboard and mouse operation data according to the marks by following the user's command. The keyboard and mouse emulator 106 coupled to the keyboard and mouse recording unit 102, emulates the keyboard 120 and mouse 130 according to the reproduced operation data to replay the keyboard and mouse operation to the computer. Usually, the transmitted keyboard and mouse data is a kind of serially transmitted data, and the process data inside the operation data recording/reproducing system 100 is transmitted in parallel. The other purpose of the keyboard and mouse emulator 106 is to transform the parallel transmission data inside the operation data recording/reproducing system 100 into the serial transmission keyboard and mouse data for the computers. Specifically, the keyboard and mouse recording unit 102 and the mark generator 108 can be realized in respective integrated circuits or as different sections of the firmware program executed to control the keyboard and mouse operation data recording/reproducing system 100.

For example, the user starts to record the operation of the keyboard 120 and mouse 130. Several series of operation data corresponding to keyboard and mouse input can be recorded into the memory with marks, e.g. reference frequency marks or count marks. These marks are generated and added indexes automatically for marking the events of the operation data as intervals between events without the user's handling, i.e. the operation data are recorded with an axis of reference frequency indexes or count indexes and the axis of the reference frequency or the count indexes with be ripped out when the operation data are reproduced to the keyboard and mouse emulator. Furthermore, by accessing the operation data stored in the memory 104, the user can edits or programs these several series of operation data with the axis of the reference frequency indexes or count indexes even as cutting a film as a montage and stores desired, or edited keyboard and mouse operation data, then when the user wants to replay the desired, or edited keyboard and mouse operation, the user sends a reproducing command to the keyboard and mouse recording unit 102 for accessing the memory 104 and the keyboard and mouse recording unit 102 reproduces the keyboard and mouse operation data to the keyboard and mouse emulator 106. The keyboard and mouse recording unit 102 reproduces desired, or edited the operation data by the reference frequency indexes or the counter indexes to reconstruct the operation exactly as user's previous operation on the keyboard and mouse. The keyboard and mouse emulator 106 receives the reproduced keyboard and mouse operation data to replay the keyboard and mouse operation to the computer 140. The user even can set the number of times for repeating the keyboard and mouse operation.

Please refer to FIG. 1B illustrating a block diagram of a keyboard and mouse operation data recording/reproducing system 200 for further including a switch for selecting the source of keyboard and mouse operation data according to second embodiment of the present invention. In this embodiment, the operation data recording/reproducing system 200 includes almost the same components as the first embodiment shown in FIG. 1A. The difference from the first embodiment is adding the switch 112 between the keyboard and mouse controller 110, the keyboard and mouse recording unit 102 and the keyboard and mouse emulator 106, respectively. The switch 112 selects either the reproduced operation data from the keyboard and mouse recording unit 102 or the keyboard and mouse operation data from the keyboard and mouse controller 106 to be transmitted to the keyboard and mouse emulator 106. In this embodiment, if the user doesn't reproduce the operation of the keyboard 120 and mouse 130, the keyboard and mouse operation data transformed from the keyboard and mouse controller 110 are directly sent to the computer 140 via the keyboard and mouse emulator 106. The keyboard and mouse recording unit 102, the memory 104 and the mark generator 108 of the operation data recording/reproducing system 200 will be drove into idle status for better energy performance and therefore longer lifetime can be achieved.

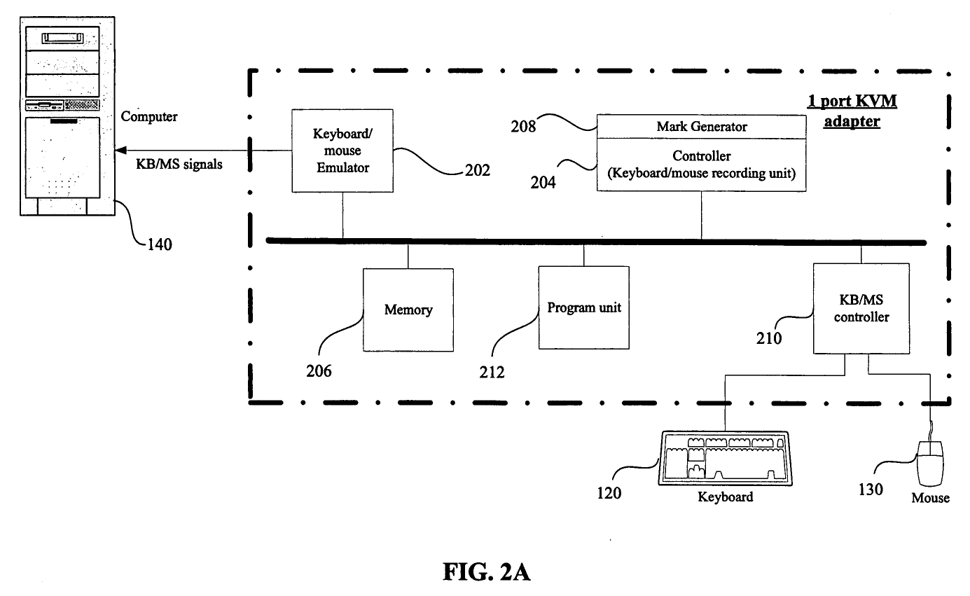

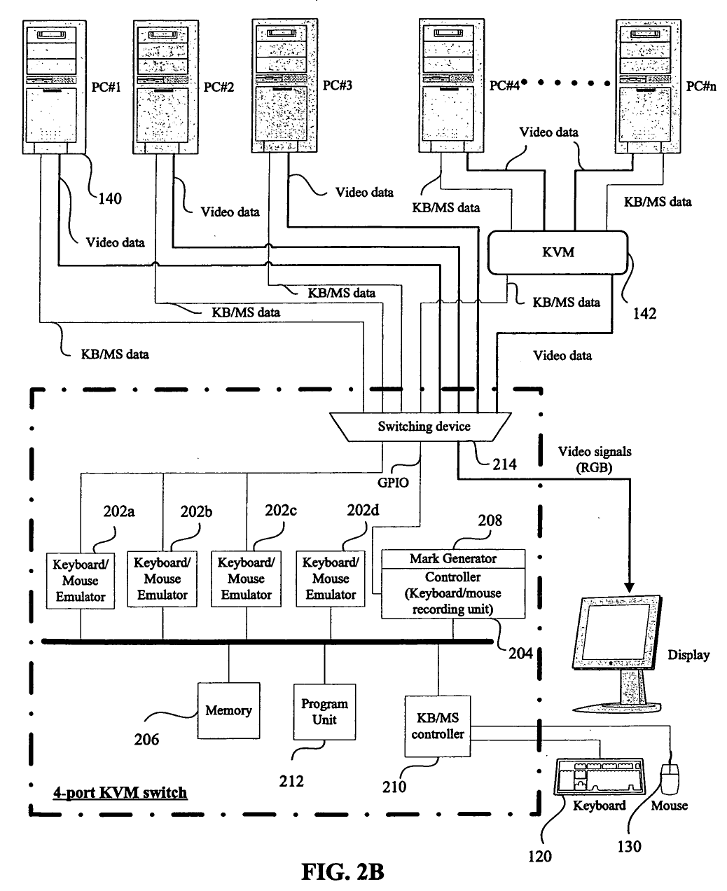

Please refer to FIG. 2A, which illustrates a block diagram of a keyboard and mouse operation data recording/reproducing 1-port KVM adapter according to third embodiment of the present invention. In this embodiment, the operation data recording/reproducing 1-port KVM adapter includes a keyboard and mouse emulator 202, a controller 204, a memory 206, a mark generator 208 and a keyboard and mouse controller 210. As same as the first and second embodiments, the recording/reproducing 1-port KVM adapter is coupled to a keyboard 120 and a mouse 130 through the keyboard and mouse controller 210 and coupled to a computer 140 (PC) via the keyboard and mouse emulator 202.

The video related hardware like a display and the related circuitry inside the KVM are not shown. Moreover, the 1-port KVM adapter includes a program unit 212. Comparing to the first embodiment, The keyboard and mouse emulator 202, the memory 206, the mark generator 208 and the keyboard and mouse controller 210 still work properly according to their exist purpose. The difference from the first embodiment is that the job of keyboard and mouse recording unit 102 is in charge of the controller 210. Due to the necessity of other keyboard-video-mouse data process in the KVM adapter, the program unit 212 can be a firmware inside for the controller 204, storing the software programs for the controller 204 to control the other keyboard-video-mouse data process and the program unit 212 supports the keyboard and mouse operation data recording/reproducing function at the same time. As same as the first embodiment, the controller 204 and the mark generator 208 (furthermore, with the program unit 212) can be realized in one integrated circuit or as a firmware program executed to control the KVM adapter.

Please refer to FIG. 2B that illustrates a functional block diagram of a keyboard-video-mouse (KVM) switch capable of recording/reproducing keyboard and mouse operation data of a set of keyboard and mouse according to fourth embodiment of the present invention. In fourth embodiment, a 4-port KVM switch is illustrated, however, the present invention also can be employed to the KVM switch with more than 4 ports. The 4-port KVM switch includes four keyboard and mouse emulators (202a, 202b, 202c, and 202d), a controller 204, a memory 206, a mark generator 208 and a keyboard and mouse controller 210. The 4-port KVM switch is coupled to a keyboard 120 and a mouse 130 through the keyboard and mouse controller 210 and coupled to a computer 140 (PC#1 represents) via the keyboard and mouse emulator 202a. Moreover, the 4-port KVM switch includes a program unit 212. Due to the necessity of original keyboard-video-mouse data process in the KVM switch, the program unit 212 can be a firmware inside for the controller 204, storing the software programs for the controller 204 to control the other keyboard-video-mouse data process and the program unit 212 supports the keyboard and mouse operation data recording/reproducing function at the same time. As same as the third embodiment, the controller 204 and the mark generator 208 (furthermore, with the program unit 212) can be realized in respective integrated circuits or as different sections of the firmware program executed to control the KVM switch. The KVM switch further includes a switching device 214. The switching device 214 routes the keyboard and mouse operation data to the corresponding computer (one of the PC#1˜PC#n) of the keyboard and mouse emulator (202a, 202b, 202c, and 202d) according to the GPIO (General Purpose Input Output) from the controller 204.

Furthermore, with the cascade expanding connecting function, the 4-port KVM switch can be coupled to computer PC#4˜PC#n by another KVM switch 142 via the keyboard and mouse emulator 202d and the switching device 214. The video related hardware only shows the display of a console and the simple related circuitry inside the KVM.

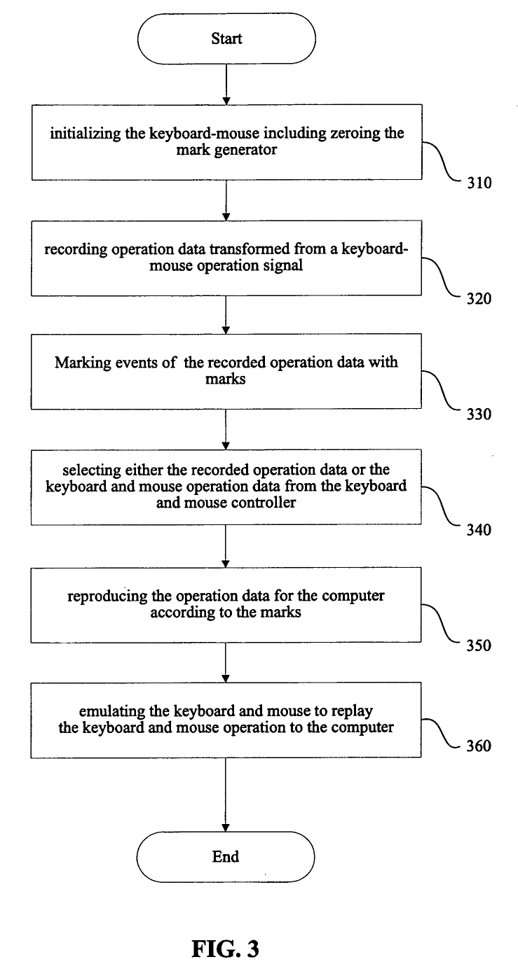

Please refer to FIG. 3. It shows a flowchart of the method for recording/reproducing a keyboard and mouse operation data of a set of keyboard and mouse. The method of recording/reproducing a keyboard and mouse operation data is described below:

In Step 310, initializing the set of keyboard and mouse including zeroing the mark generator;

In Step 320, recording keyboard and mouse operation data transformed from a keyboard and mouse operation signal;

In Step 330, marking events of the recorded operation data with marks while the operation data is stored;

In Step 340, selecting either the recorded operation data from the memory or the keyboard and mouse operation data from the keyboard and mouse controller;

In Step 350, reproducing the recorded operation data for the computer according to the marks;

In Step 360, emulating the keyboard and mouse to replay the keyboard and mouse operation to the computer.

According to the keyboard and mouse operation data recording/reproducing system and method thereof, the user cannot only recording/reproducing the operation data but also further editing the operation data after storing the operation data into the memory and before reproducing the recorded operation data for the computer. The user may edit the operation data by accessing the memory to view the content of the operation data. The user may cut, combine or do some montage on the operation data to provide more possibility of replaying the keyboard and mouse operation to the computer but not only recording and reproducing the operation data. As fore mentioned test job, many routine repeated, monotonous and regular test on computerized productions can be reduced and the recording/reproducing or even editing ability on the input of keyboard and mouse before the operation system (of the computers coupled with) is alive according to the present invention is more powerful to the test job which the prior art can not provide.

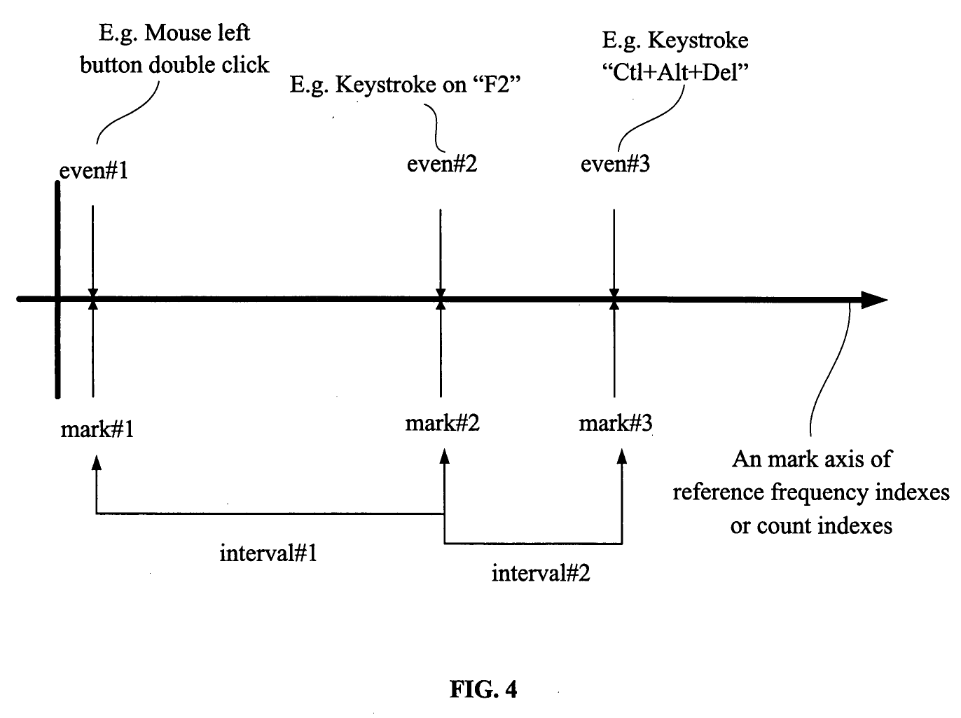

Please refer to FIG. 4,which shows an illustration for marking events of the recorded operation data as intervals with an axis of the reference frequency indexes or the counting indexes. For example, there is an event#l (Mouse left button double click) and an event#2 (Keystroke on “F2”) subsequent to the even#1 in time, a mark#1 will be interposed to the event#1 and a mark#2 will be interposed to the event#2 when the event#1 and an event#2 are recorded to establish an interval#1. If there is an event#3 (Keystroke on “Ctl+Alt+Del”) subsequent to the event#2 in time, a mark#3 will be interposed to the event#3 when the event#2 and an event#3 are recorded to establish an interval#2. The marks can be derived from counting the number of the reference clock having the reference frequency indexes generated by a reference frequency generator or from calculating the counting the number of the reference counting having the count indexes by a counter. The reference frequency generator generates the reference frequency just like a clock running having a regular frequency. With each event occurs during the recording, the reference frequency generator will generate each unique reference frequency index as a mark interposed to the event. Two marks will establish one interval. The marks the operation data as described above will be ripped out when the operation data are reproduced to the keyboard and mouse emulator by the keyboard and mouse recording unit. However, the keyboard and mouse recording unit does reproduce the operation data accurately according to the intervals between any two events so that the keyboard and mouse emulator will replay the recorded keyboard and mouse operation to the computer faithfully.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A recording/reproducing system of keyboard and mouse operation data, coupled to a keyboard, a mouse and at least one computer, to route keyboard, video, mouse operation data between the keyboard, the mouse and the computers, the keyboard and mouse operation recording/reproducing system comprising:
a keyboard and mouse recording unit, watching for the keyboard and mouse to record the operation data transformed from keyboard and mouse signal and reproduce the recorded operation data;
a memory, coupled to the keyboard and mouse recording unit, storing the recorded operation data;
a mark generator coupled to the keyboard and mouse recording unit, generating a plurality of marks for events of the recorded operation data while the recorded operation data is stored in the memory; and
a keyboard and mouse emulator, emulating the keyboard and mouse according to the reproduced operation data to replay the keyboard and mouse operation to the computer.

2. The system of claim 1, wherein the keyboard and mouse recording unit receives the marks from the mark generator to mark the events of the recorded operation data as intervals inbetween while the recorded operation data is stored to the memory.

3. The system of claim 1, wherein the mark generator is a reference frequency generator to generate reference frequency indexes as the marks in the recorded operation data.

4. The system of claim 1, wherein the mark generator is a counter to generate counting indexes as the marks in the recorded operation data.

5. The system of claim 1, wherein the keyboard and mouse recording unit reproduces the recorded keyboard and mouse operation data according to the marks.

6. The system of claim 1, further comprising a keyboard and mouse controller, transforming the keyboard and mouse operation signal into the keyboard and mouse operation data.

7. The system of claim 1, further comprising a switch, selecting either the reproduced operation data from the keyboard and mouse recording unit or the keyboard and mouse operation data from the keyboard and mouse controller to be transmitted to the keyboard and mouse emulator.

8. A keyboard-video-mouse (KVM) switch capable of recording/reproducing keyboard and mouse operation data, coupling to a keyboard, a mouse, a display and at least one computer, to route keyboard, mouse operation data between the keyboard, the mouse, the display and the computers, the switch comprising:
a controller, controlling the KVM switch to record the operation data of keyboard and mouse signal and to reproduce the recorded keyboard and mouse operation data;
a memory, coupled to the controller, storing the recorded operation data;
a mark generator, coupled to the controller, generating a plurality of marks for events of the recorded operation data while the recorded operation data is stored in the memory; and
at least one keyboard and mouse emulator, emulating the keyboard and mouse according to the reproduced operation data to replay the keyboard and mouse operation.
a switching device, routing the keyboard and mouse operation data of the replayed keyboard and mouse operation to the corresponding computer of the keyboard and mouse emulator.

9. The system of claim 8, wherein the controller receives the marks from the mark generator to mark the events of the recorded operation data as intervals inbetween while the recorded operation data is stored to the memory.

10. The system of claim 8, wherein the mark generator is a reference frequency generator to generate reference frequency indexes as the marks in the recorded operation data.

11. The system of claim 8, wherein the mark generator is a counter to generate counting indexes as the marks in the recorded operation data.

12. The system of claim 8, wherein the controller reproduces the recorded keyboard and mouse operation data according to the marks.

13. The system of claim 8, further comprising a keyboard and mouse controller, transforming the keyboard and mouse signal into the keyboard and mouse operation data.

14. A method for recording/reproducing a keyboard and mouse operation data of a set of keyboard and mouse of a console for a connected computer, the method comprising the steps of:
recording keyboard and mouse operation data transformed from a keyboard and mouse operation signal;
marking events of the recorded operation data with marks while the operation data is stored; and
reproducing the recorded operation data for the computer according to the marks.

15. The method of claim 14, further comprising a step of initializing the set of keyboard and mouse including zeroing the mark generator before the recording step.

16. The method of claim 14, wherein the keyboard and mouse operation signal is transformed into the operation data by a keyboard and mouse controller coupled with the keyboard and mouse device.

17. The method of claim 14, further comprising a step of selecting either the recorded operation data or the keyboard and mouse operation data from the keyboard and mouse controller before the step of reproducing the keyboard and mouse operation data.

18. The method of claim 14, further comprising a step of emulating the keyboard and mouse to replay the keyboard and mouse operation to the computer after the step of reproducing the keyboard and mouse operation data.

19. The method of claim 14, wherein the marks mark the events of the recorded operation data as intervals inbetween.

20. The method of claim 14, wherein the marks are reference frequency indexes generated by a reference frequency generator.

21. The method of claim 14, wherein the marks are counting indexes generated by a counter.
